(19) United States
(12) Patent Application Publication
(10) Pub. No.: US 2026/0161119 A1
(43) Pub. Date: Jun. 11, 2026

(54) FIXING DEVICE

(71) Applicant: Sharp Kabushiki Kaisha, Osaka (JP)

(72) Inventor: Yuusuke ITAGAKI, Sakai City (JP)

(21) Appl. No.: 19/395,295

(22) Filed: Nov. 20, 2025

(30) Foreign Application Priority Data
Dec. 6, 2024 (JP) 2024-213320

(51) Int. Cl. G03G 15/20

(52) U.S. Cl. CPC G03G 15/2017; G03G 15/2064; G03G 2215/2035

(57) ABSTRACT

A fixing device includes: a fixing belt having a cylindrical shape in an axial direction; a belt guide that holds both ends of the fixing belt; a frame that supports the belt guide; and a pressure member that presses the fixing belt while abutting against the fixing belt in a direction intersecting the axial direction. The belt guide has a flange portion that is fixed by abutting against the frame, and a standing portion that is provided adjacent to the flange portion and abuts against an inner periphery of the fixing belt, a groove portion that is provided in the flange portion on an outer periphery of the standing portion and capable of receiving an end portion of the fixing belt, and a through hole that communicates a surface of the flange portion facing the frame with the groove portion, and an abutment member that is disposed inside the through hole and is biased to abut against the end portion of the fixing belt.

### CROSS REFERENCE TO RELATED APPLICATION

The present application claims priority from Japanese Application JP2024-213320, the content of which is hereby incorporated by reference into this application.

### BACKGROUND OF THE INVENTION

### 1. Field of the Invention

The disclosure relates to a fixing device.

In a known fixing device including a substantially cylindrical fixing belt and a fixing roller, a configuration has been disclosed in which a belt regulating member provided on the fixing roller is provided to prevent the fixing belt from meandering.

### 2. Description of the Related Art

In a known fixing device including a belt regulating member provided on a fixing roller to prevent a fixing belt from meandering, the belt regulating member forms a flange, and the entire end portion of the fixing belt comes into contact with the belt regulating member. The belt regulating member is configured to release a pressing force when the belt regulating member comes into contact with the end portion of the fixing belt by means of an elastic member disposed between the belt regulating member and a fixed flange portion. However, even with such a configuration, the end portion of the fixing belt may come into contact with a belt guide, and the end portion of the fixing belt or the belt regulating member may be scraped, causing the belt shape at the end portion of the fixing belt to temporarily lose its substantially cylindrical shape. A fixing belt that cannot maintain a substantially cylindrical shape at its end portion may be caught by the belt regulating member, resulting in belt damage.

The disclosure has been made to solve the above-mentioned problem, and an object thereof is to provide a fixing device with improved durability against tearing of a fixing belt.

### SUMMARY OF THE INVENTION

A fixing device according to the disclosure includes: a fixing member having a cylindrical shape in an axial direction; a holding member that holds both ends of the fixing member; a frame that supports the holding member; and a pressure member that presses the fixing member while abutting against the fixing member in a direction intersecting the axial direction. The holding member has a flange portion that is fixed by abutting against the frame, and a standing portion that is provided adjacent to the flange portion and abuts against an inner periphery of the fixing member, a groove portion that is provided in the flange portion on an outer periphery of the standing portion and capable of receiving an end portion of the fixing member, and a through hole that communicates a surface of the flange portion facing the frame with the groove portion, and an abutment member that is disposed inside the through hole and is biased to abut against the end portion of the fixing member.

Preferably, the flange portion faces a part of the end portion of the fixing member, and the standing portion stands on the flange portion facing the part of the end portion of the fixing member.

More preferably, a plurality of the through holes are provided.

More preferably, the fixing member has a width such that both end portions of the fixing member are maintained in a state of being constantly received in the groove portion of the holding member.

The abutment member may have a spherical shape having a diameter substantially the same as a diameter of the through hole.

According to the disclosure, since the end portion of the fixing member abuts against an abutment member that is biased to abut against the end portion of the fixing member at a part of the end portion of the fixing member, the wear at the location of the abutment member that abuts against the end portion of the fixing member can be limited to a range shorter than a circumferential length of the fixing belt, and the end surface of the end portion of the fixing member on the belt guide side can move in the direction in which a bias force is applied. That is, the end surface of the fixing member on the belt guide side, with which the fixing member is in contact, is released in the direction in which the bias force is applied. Furthermore, the groove portion that receives the end portion of the fixing member maintains the shape of the end portion of the fixing member in a substantially circular shape, thereby suppressing temporary deformation of the fixing member. As a result, it is possible to provide a fixing device with improved durability against tearing of the fixing belt.

The above-described objects, other objects, features, and advantages of the disclosure will become more apparent from the detailed description of examples given below with reference to the drawings.

### BRIEF DESCRIPTION OF THE DRAWINGS

FIG. 1 is a diagram illustrating a nip portion of a fixing device according to an embodiment of the disclosure.

FIG. 2 is a cross-sectional view illustrating a fixing belt according to a first embodiment of the disclosure, viewed from a width direction thereof, and a belt guide that holds an end portion of an inner periphery of the fixing belt.

FIG. 3 is a diagram illustrating the end portion of the belt guide as viewed from a direction indicated by an arrow 3-3 in FIG. 2.

FIG. 4 is a perspective view of the belt guide illustrated in FIG. 3, viewed from a standing portion side that holds the fixing belt.

FIG. 5 is a perspective view of the belt guide illustrated in FIG. 4, viewed from a frame side opposite to that of FIG. 4.

FIG. 6 is a perspective view illustrating a belt guide according to a second embodiment of the disclosure.

### DETAILED DESCRIPTION OF THE INVENTION

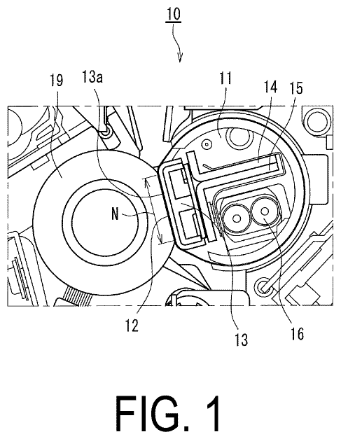

An embodiment according to the disclosure will be described in detail below with reference to the drawings. FIG. 1 is a diagram illustrating a nip portion of a fixing device according to an embodiment of the disclosure. With reference to FIG. 1, a fixing device 10 includes a fixing heating member 11 which is a cylindrical portion disposed on the right side in the diagram, and a pressure member 19 which is a cylindrical portion disposed on the left side in the drawing. The fixing heating member 11 includes a fixing belt (fixing member) 12 provided at an outer periphery of the fixing heating member 11, a contact member 13 provided inside the fixing belt 12, an inverted L-shaped sheet metal 14 and an L-shaped sheet metal 15 provided adjacent to each other on a side of the contact member 13 opposite to the fixing belt 12, and a heater 16 provided adjacent to the L-shaped sheet metal 15.

The pressure member 19 abuts against a flat portion 13a of the contact member 13 to form a nip portion N indicated by an arrow in the drawing, and a sheet (not illustrated) is transported upward from below to the nip portion N to perform a fixing operation.

### First Embodiment

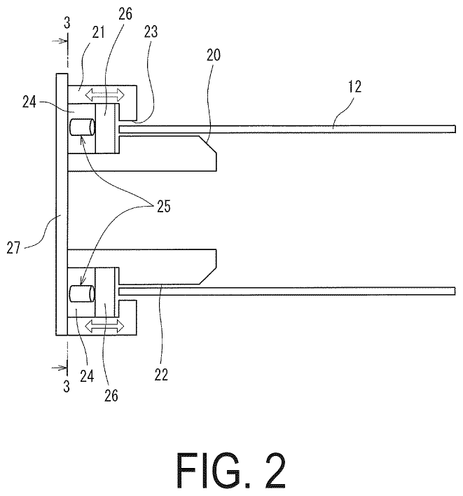

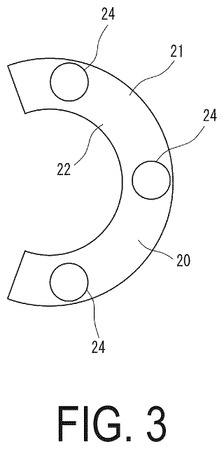

First, a first embodiment of the disclosure will be described. FIG. 2 is a cross-sectional view illustrating a fixing belt 12 according to the first embodiment of the disclosure, viewed from a direction orthogonal to an axis thereof, and a belt guide (holding member) 20 that holds an end portion of an inner periphery of the fixing belt 12, and FIG. 3 is a diagram illustrating an end portion of the belt guide 20 as viewed from the axial direction of the fixing belt, with the end portion of the belt guide 20 indicated by an arrow 3-3 in FIG. 2.

In FIGS. 2 and 3, only one end portion of the fixing belt 12 is illustrated, but the other end portion is the same.

Referring to FIGS. 2 and 3, the belt guide 20 includes a flange portion 21 forming an outer periphery, a standing portion 22 provided to protrude axially inward and be separated from an inner periphery of the flange portion 21 by an interval corresponding to a groove portion 23, and the groove portion 23 provided on an outer periphery of the standing portion 22 along the standing portion 22. The flange portion 21 and the standing portion 22 have their end surfaces fixed to a disk-shaped frame 27, and the fixing belt 12 has its end portion held by an inner peripheral portion of the standing portion 22. When the fixing belt 12 moves to one of the belt guides provided on both ends while rotating, the end portion moves into the groove portion 23. The fixing belt 12 has a width such that both end portions thereof are maintained in a state of being constantly received in the groove portion 23 of the belt guide 20.

In this way, the end portion of the fixing belt 12 is received in the groove portion 23, and therefore, the end portion of the fixing belt 12 is guided from both the inner peripheral side and the outer peripheral side of the belt guide, thereby suppressing deformation of the end portion, which may cause tearing of the fixing belt 12. Therefore, the durability against tearing of the fixing belt 12 can be improved.

As illustrated in FIGS. 2 and 3, the belt guide 20 has a cylindrical through hole 24 that communicates the surface of the flange portion 21 and the standing portion 22 facing the frame 27 with the groove portion 23, and a cylindrical abutment member 26 that is biased by a spring 25 to abut against the end portion of the fixing belt 12 is provided inside the through hole 24. In FIG. 3, the groove portion 23 that separates the flange portion 21 and the standing portion 22 that constitute the belt guide 20 in the circumferential direction is omitted from the illustration.

The abutment member 26 has a strength that can withstand friction with the fixing belt 12 and a thickness to such an extent that the posture of the abutment member 26 does not change even if it is displaced inside the through hole 24. When the fixing belt 12 moves in its width direction and abuts against the abutment member 26, the direction in which the abutment member 26 moves is indicated by a thick arrow in FIG. 2.

In this way, the abutment member 26 biased by the spring 25 is provided to abut against the end portion of the fixing belt 12, and the end surface of the belt guide 20 can move (escape) in the direction in which a bias force is applied when the fixing belt 12 starts to rotate, thereby improving the durability against tearing of the fixing belt 12.

As illustrated in FIG. 3, the belt guide 20 is provided only on the semicircular portion of the fixing belt 12 on the side where a pressure member 19 (see FIG. 1) is not provided, and three through holes 24 in which the springs 25 and the like are provided are also provided at approximately 90-degree intervals on the semicircular portion on the side where the pressure member 19 is not provided, as illustrated.

The number of through holes 24 may be determined appropriately depending on the mass of the fixing belt 12 and the diameter of the through holes 24. The mass of the fixing belt 12 varies depending on the width of the paper that can be passed through, the thickness of the fixing belt 12, and the diameter of the fixing belt 12. Generally, the greater the mass of the fixing belt 12, the greater the bias force. Therefore, it is conceivable to increase the number of through holes 24. Furthermore, the size of the spring 25 varies depending on the diameter of the through hole 24. The smaller the spring 25, the weaker the force that resists the bias force. Therefore, it is conceivable to increase the number of through holes 24.

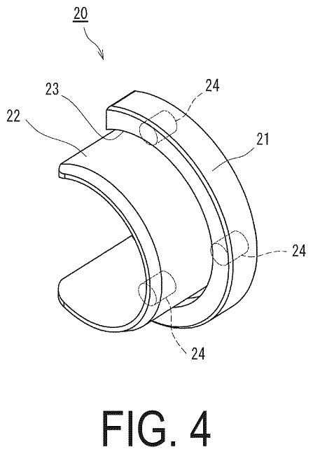

FIG. 4 is a perspective view of the belt guide 20 illustrated in FIG. 3, viewed from the side of the standing portion 22 that holds the fixing belt 12. As illustrated in FIG. 4, a substantially semicircular standing portion 22 is provided on the inner periphery of a flange portion 21 that is substantially semicircular when viewed from the axial direction of the fixing belt 12, and a through hole 24 shown by a dotted line is provided on the back side of a groove portion 23 provided between the flange portion 21 and the standing portion 22.

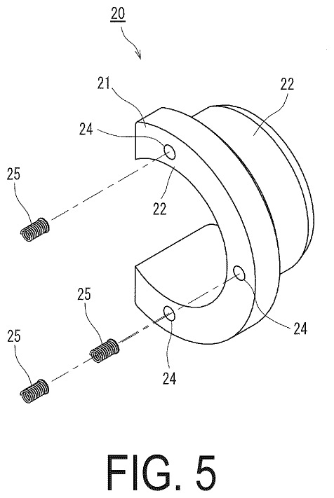

FIG. 5 is a perspective view of the belt guide 20 illustrated in FIG. 4, viewed from the frame 27 side (see FIG. 2), which is the opposite side to that of FIG. 4, and here, the frame 27 is omitted from the illustration. Here, as in FIG. 3, the groove portion 23 (see FIG. 2) that separates the flange portion 21 and the standing portion 22 in the circumferential direction is omitted from the illustration.

Here, the spring 25 that biases the abutment member (not illustrated), which is originally provided inside the through hole 24 and cannot be viewed from the outside, is shown pulled out to the outside of the through hole 24.

### Second Embodiment

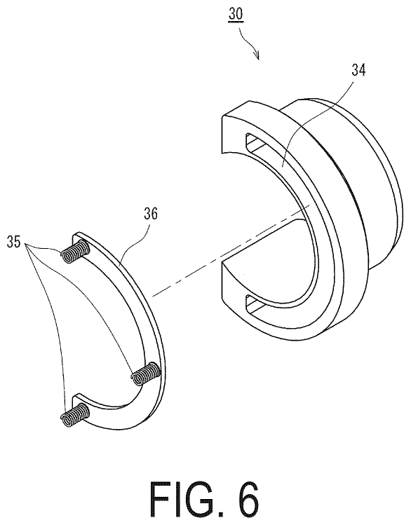

Next, a second embodiment of the disclosure will be described. FIG. 6 is a perspective view illustrating a belt guide 30 according to a second embodiment of the disclosure, and corresponds to FIG. 5 in the first embodiment. Here, as in FIG. 5, the frame 27 (see FIG. 2) is omitted from the illustration.

Referring to FIG. 6, in the second embodiment, the belt guide 30 basically has the same configuration as in the first embodiment. In the first embodiment, the positions of the through holes 24 in which the springs 25 and the abutment members 26 are provided are limited to three locations at 90-degree intervals. However, in the second embodiment, an abutment member 36 is not provided individually, but is formed of a semicircular, one-piece plate material, and a through hole 34 is a semicircular, elongated hole, which are different from the first embodiment. Springs 35 are provided at three locations at 90-degree intervals and are held by the frame 27 in the same manner.

In this case, the semicircular integral abutment member 36 and the spring 35 that biases it, which are originally provided inside the through hole 34 and cannot be viewed from the outside, are shown pulled out to the outside.

In this embodiment, any protrusion at any position on the fixing belt 12 can be received by the abutment member 36, which is a semicircular, one-piece plate material.

In this embodiment, three springs 35 are provided to bias the abutment member 36, which is a semicircular, one-piece plate material, but the number of springs 35 can be determined appropriately depending on the magnitude of the bias force of the fixing belt 12, as in the other embodiments.

In the first embodiment, the case where the abutment member 26 is cylindrical has been described, but the disclosure is not limited thereto, and the abutment member 26 may have a spherical shape having a diameter substantially the same as the diameter of the through hole.

By forming the abutment member 26 into a spherical shape having a diameter substantially the same as the diameter of the through hole, wear caused by sliding contact between the end portion of the fixing belt 12 and the abutment member 26 is suppressed.

### Third Embodiment

Next, a third embodiment of the disclosure will be described with reference to FIG. 2. FIG. 2 is a cross-sectional view illustrating the belt guide 20 according to the first embodiment of the disclosure, and the groove portion 23 is configured such that the width on the through hole side is the same as the width on the receiving side of the fixing belt 12. In the third embodiment of the disclosure, the groove portion 23 is configured such that the width on the receiving side of the fixing belt 12 is narrower than the width on the through hole side of the groove portion 23.

In this embodiment, the guide slightly inside the end portion of the fixing belt 12 is made within strict limits, and the guide of the end portion of the fixing belt 12 that comes into sliding contact with the abutment member 26 is designed with a margin. With this configuration, the sliding contact with the abutment member 26 can be made with a slight play while guiding the substantial end portion of the fixing belt 12, thereby suppressing deformation of the fixing belt 12 while reducing friction with the abutment member 26.

The disclosure may be carried out in other various forms without departing from the spirit or essential characteristics thereof. Thus, the above embodiments are merely examples and should not be interpreted as limiting. All modifications and changes equivalent in scope with the claims of the disclosure are included in the scope of the disclosure.

### Industrial Applicability

According to the disclosure, a fixing device having improved durability against tearing of a fixing belt can be provided, and therefore, the disclosure is useful as a fixing device.

1. A fixing device comprising:
a fixing member having a cylindrical shape in an axial direction;
a holding member that holds both ends of the fixing member;
a frame that supports the holding member; and
a pressure member that presses the fixing member while abutting against the fixing member in a direction intersecting the axial direction,
wherein the holding member has
a flange portion that is fixed by abutting against the frame, and a standing portion that is provided adjacent to the flange portion and abuts against an inner periphery of the fixing member,
a groove portion that is provided in the flange portion on an outer periphery of the standing portion and capable of receiving an end portion of the fixing member, and a through hole that communicates a surface of the flange portion facing the frame with the groove portion, and
an abutment member that is disposed inside the through hole and is biased to abut against the end portion of the fixing member.

2. The fixing device according to claim 1, wherein the flange portion faces a part of the end portion of the fixing member, and the standing portion stands on the flange portion facing the part of the end portion of the fixing member.

3. The fixing device according to claim 1, wherein a plurality of the through holes are provided.

4. The fixing device according to claim 1, wherein the fixing member has a width such that both end portions of the fixing member are maintained in a state of being constantly received in the groove portion of the holding member.

5. The fixing device according to claim 1, wherein the abutment member has a spherical shape having a diameter substantially the same as a diameter of the through hole.
